(19) United States
(12) Patent Application Publication
(10) Pub. No.: US 2021/0351513 A1
(43) Pub. Date: Nov. 11, 2021

(54) ANTENNA SYSTEM AND WIFI ROUTER APPARATUS

(71) Applicant: Space Exploration Technologies Corp., Hawthorne, CA (US)

(72) Inventors: Young Jun Song, Sammamish, WA (US); Bhaskar S. Vadathavoor, Sunnyvale, CA (US); Anthony Sims, Manhattan Beach, CA (US); Remy D. Labesque, Manhattan Beach, CA (US); Javier Verdura, Palos Verdes, CA (US); Leonardo J. Vasquez, Irvine, CA (US); Mohsen Zolghadri-Jahromi, Laguna Niguel, CA (US)

(73) Assignee: Space Exploration Technologies Corp., Hawthorne, CA (US)

(21) Appl. No.: 16/869,514

(22) Filed: May 7, 2020

(51) Int. Cl. H01Q 9/26; H01Q 1/42; H01Q 5/307; H01Q 5/10

(52) U.S. Cl. CPC H01Q 9/26; H01Q 5/10; H01Q 5/307; H01Q 1/42

(57) ABSTRACT

An antenna system includes a first metal housing portion having a metal housing connecting edge, the first metal housing portion having a triangular side profile, and a second non-metal housing portion having a non-metal housing connecting edge, the non-metal housing connecting edge being complimentary to the metal housing connecting edge of the first metal housing, the second non-metal housing portion having a triangular side profile. A first and second dipole antenna are printed on a circuit board positioned in the non-metal housing portion. The first and second dipole antennas are configured such that the direction of the first and second dipole currents are approximately normal to a plane defined by the metal housing connecting edge.

### FIELD OF THE INVENTION

The present technology pertains to Wi-Fi routers and more specifically to an antenna configuration and router casing structure that provides a specific radiation pattern.

### BACKGROUND

Antennas radiate electromagnetic signals and receive the same. Radiated signals can have certain patterns emanating from the antenna that can be impacted by objects in the environment. Metal objects can particularly impact the transmission of electromagnetic signals. Antenna design should take into account such objects.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof that are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates an exterior view of a housing for a Wi-Fi router;

FIG. 1B illustrates a non-metal portion of the housing for a Wi-Fi router;

FIG. 1C illustrates a side view of the non-metal portion of the housing;

FIG. 1D illustrates a side view of a metal portion of the housing;

FIG. 1E illustrates a sectional view of the metal portion of the housing;

FIG. 2 illustrates an example antenna structure configured for the housing;

FIG. 3 illustrates an example printed circuit board with a first portion of the dipole antennas;

FIG. 4 illustrates an example printed circuit board with a second portion of the dipole antennas;

FIG. 5A illustrates an example structure for the trace components of a dipole antenna;

FIG. 5B illustrates two dipole antennas in the housing structure;

FIG. 5C illustrates a side view of the two dipole antennas in the housing with antenna spacing examples; and

FIG. 6 illustrates computer components that can be applicable to an embodiment disclosed herein.

### DESCRIPTION OF EXAMPLE EMBODIMENTS

Various example embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the example embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative example embodiments mutually exclusive of other example embodiments. Moreover, various features are described which may be exhibited by some example embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various example embodiments given in this specification.

Without intent to limit the scope of the disclosure, examples of instruments, apparatus, methods and their related results according to the example embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

For clarity of explanation, in some instances the present technology may be presented as including individual functional blocks including functional blocks comprising devices, device components, steps or routines in a method embodied in software, or combinations of hardware and software.

### Overview

The present disclosure addresses the issue raised above with respect to a structure for antennas and a router that can increase bandwidth in a specific housing structure. The housing disclosed herein provides a particular structure with sheer edges and surfaces that can give the user who is viewing the housing an optical illusion with respect to how the housing can even be balanced. For example, the side surfaces, top and bottom surfaces as well as the front and rear surfaces of the housing are each triangular in shape which can give the viewer the sense that the housing is sitting and somehow balancing on a sharp edge. The particular angles and sizes of the respective triangular surfaces can vary while maintaining the overall appearance of the housing. When the housing has such a configuration, in order to provide wireless coverage in a room or an area of the router, the antenna or antennas should be configured with any metal portions of the housing in mind to provide a proper radiation pattern.

An example Wi-Fi router system includes a metal housing portion having a metal housing connecting edge, the metal housing portion having a triangular side profile. The router includes a non-metal housing portion having a non-metal housing connecting edge, the non-metal housing connecting edge being complimentary to the metal housing connecting edge of the metal housing portion. The non-metal housing portion can have a triangular side profile. Inside the housing is a printed circuit board having a first feedline, the first feedline feeding a first dipole antenna positioned in the non-metal housing portion. The first dipole antenna can be configured such that a first direction of a first dipole current is approximately normal to a plane defined by the metal housing connecting edge. A second feedline can be printed on the printed circuit board. The second feedline can feed a second dipole antenna positioned in the non-metal housing portion. The second dipole antenna can be configured such that a second direction of a second dipole current is approximately normal to the plane defined by the metal housing connecting edge.

The first dipole antenna and the second dipole antenna can be configured approximately 20-50 degrees relative to a horizontal plane. Their orientation may or may not be at the same angle. The configuration or position and orientation of the two dipole antennas enables a high quality wireless data link to a user terminal in essentially each direction relative to the housing given the fact that a portion of the housing is metal. Normally this angle can be 90 degrees without any metal housing in front of antenna. However, with the presence of the metal housing, this angle is adjusted to maximize or improve the radiation coverage. One preferable angle is 30 degrees relative to the horizontal plane.

A front surface of the metal housing portion can be vertical or tilted at an angle of between 3 and 9 degrees relative to a vertical plane. A back surface of the non-metal housing portion can be vertical or tilted at an angle that is (1) approximately parallel to the angle of the front surface or (2) between 70 and 89 degrees relative to a horizontal plane. In one aspect, approximately parallel can mean parallel or within 5-10 degrees of being parallel. The metal housing portion can have a triangular bottom surface profile. The metal housing portion can include a front surface having a triangular profile. The non-metal housing portion can include a top surface having a triangular profile. Generally, the system will rest on the bottom surface of the metal housing portion. A housing of the overall Wi-Fi router system can be a combination of the metal housing portion and the non-metal housing portion connecting along a connecting edge. The housing generally has sharp edges rather than rounded edges in the example structure shown.

The dipole antennas generally can be configured to be near the top portion of the system such that the housing around the location of the antennas is primarily non-metallic. For example, the dipole antennas can be configured in a top third portion of the non-metallic housing portion such that most of the housing structure around the antennas is non-metallic, with only a smaller portion of the metal housing portion being around the antennas.

A printed balun can be configured on the printed circuit board at an end of the first feedline and/or at an end of the second feedline.

The first dipole antenna and the second dipole antenna can be configured to transmit or receive signals at approximately 2.4 GHz and/or 5 GHz in connection with an IEEE 802.11ac standard or can be configured for other wireless protocols. For example, the first dipole antenna can include a first trace and a second trace configured for signals at approximately 5 GHz. The second dipole antenna can include a third trace and a fourth trace configured for signals at approximately 5 GHz, or within a range of 5.10-5.90 GHz.

The first dipole antenna can include a fifth trace and a sixth trace configured for signals at approximately 2.4 GHz, and the second dipole antenna can include a seventh trace and an eighth trace configured for signals at approximately 2.4 GHz, or within a range of 2.40-2.48 GHz. The first trace and the fifth trace associated with the first dipole antenna can be associated with a first layer of the printed circuit board. The second trace and the sixth trace associated with the first dipole antenna can be associated with a second layer of the printed circuit board. Additionally, the third trace and the seventh trace associated with the second dipole antenna can be associated with the first layer of the printed circuit board, and the fourth trace and the eighth trace associated with the second dipole antenna can be associated with the second layer of the printed circuit board.

A first maximum radiation direction of the first dipole can be approximately parallel to the plane defined by the metal housing connecting edge. In another aspect, a second maximum radiation direction of the second dipole can be approximately parallel to the plane defined by the metal housing connecting edge.

The system disclosed herein can include an antenna structure that can be designed to provide sufficient radiation patters relative to the housing structure and characteristics. The system can provide coverage in one example for a Wi-Fi protocol (IEEE 802.11) access to the Internet. In other words, given the desired housing structure disclosed herein, the dual dipole antennas are configured to provide proper coverage for users in a building or in the range of the antenna system notwithstanding the housing being at least in part made of a metal such as aluminum. The overall system provides the desired housing look and antennas configured for sufficient Wi-Fi coverage.

### DETAILED DESCRIPTION

Generally, this disclosure relates to an antenna structure for a particular housing configuration that includes a metal component for a portion of the housing. The particular radio frequency protocol that can be applied to the systems disclosed herein can vary. In one example, the antenna structure is configured for a Wi-Fi protocol IEEE 802.11ac and can provide for 2×2 MIMO (multiple in, multiple out) radio coverage. However, there are a number of different Wi-Fi protocols and any Wi-Fi protocol or any other wireless communication protocol can be applicable to the system disclosed herein. For example, the figures herein and discussion describes particular dipole antenna trace structures on a printed circuit board. These are designed for particular frequency bands within the Wi-Fi protocol. The specific figures and description are meant to be illustrative only. For example, other antenna structures could be used in a similar orientation, placement within the housing and distance from the metal portion of the housing as the antennas disclosed herein. The overall concepts described herein combine dipole antenna orientations coordinated with a particular housing structure that has a metal portion and a non-metal portion. Further, while two antennas are shown, one antenna could be used as well as more than two antennas having similar characteristics to those disclosed herein.

The antenna structure and particular printed circuit board construction of one or more dipole antennas disclosed herein solves the problem of providing a proper radiation pattern where the housing of the antennas is at least in part made from a metal such as aluminum. Other metals could be used as well. Given the constraints of the housing having a metal component as well as the particular shape of the housing portions, the antenna design overcomes blockage from the metal housing component by the strategic positioning of the antennas within the housing as well as their orientation and separation positions.

The target radiation pattern for the system is an omnidirectional pattern in the azimuth plane due the possibility of the Wi-Fi router system being randomly placed in a room or building. As shall be shown, to overcome blockage from the metal front of the antenna housing, the antenna location, orientation, and separation were designed to provide sufficient radiation patterns particularly in the front direction where the possibility of blockage due to the metal housing portion is possible.

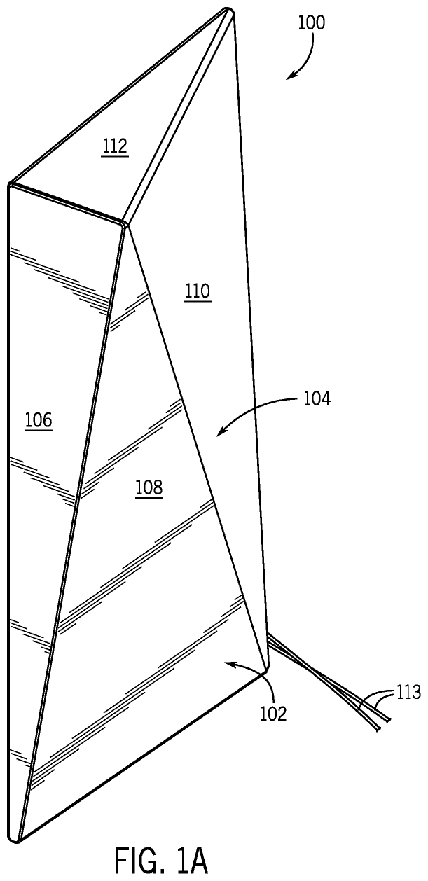

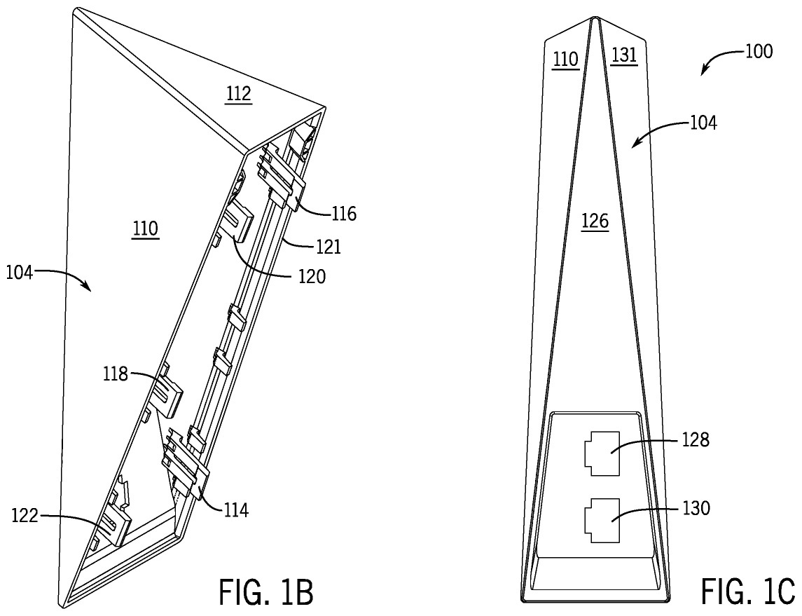

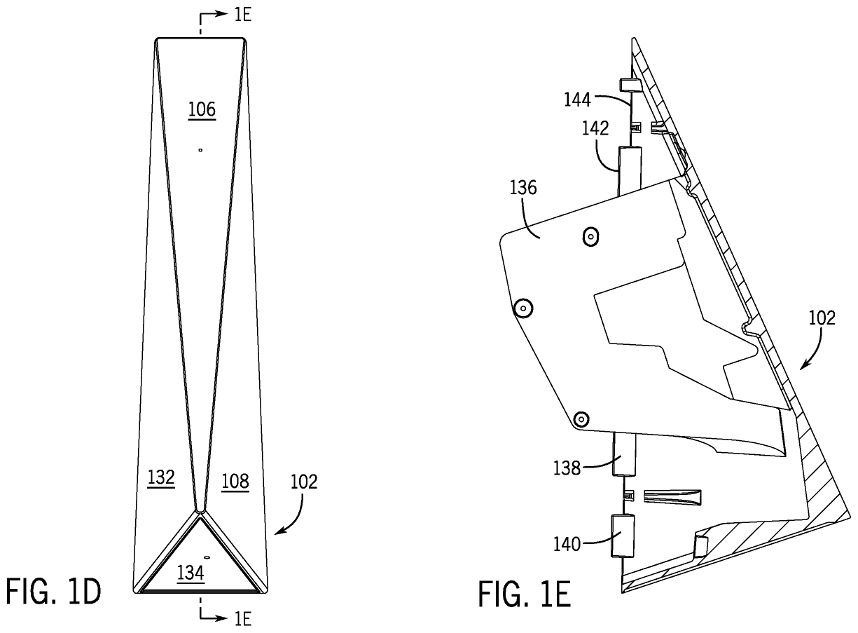

FIG. 1A illustrates an example housing 100 for a printed circuit board and antenna configuration. The antenna configuration can be designed to match generally this housing structure. A metal housing portion 102 is shown having a side profile 108 that is triangular in shape. In this example, the housing 100 is supported by a bottom surface of the metal housing portion 102. A front surface 106 is shown as also having a triangular profile. A non-metal housing portion 104 is also shown as having a side surface 110 that can have a triangular profile. Note that the top surface 112 of the system 100 is primarily made from the non-metal material and is part of the non-metal housing portion 104. The non-metal material can be, for example a plastic or other non-metallic material such as a polycarbonate. Each of the metal housing 102 and the non-metal housing can have in one example four surfaces, each of the surfaces on each housing 102/104 can be triangular in shape.

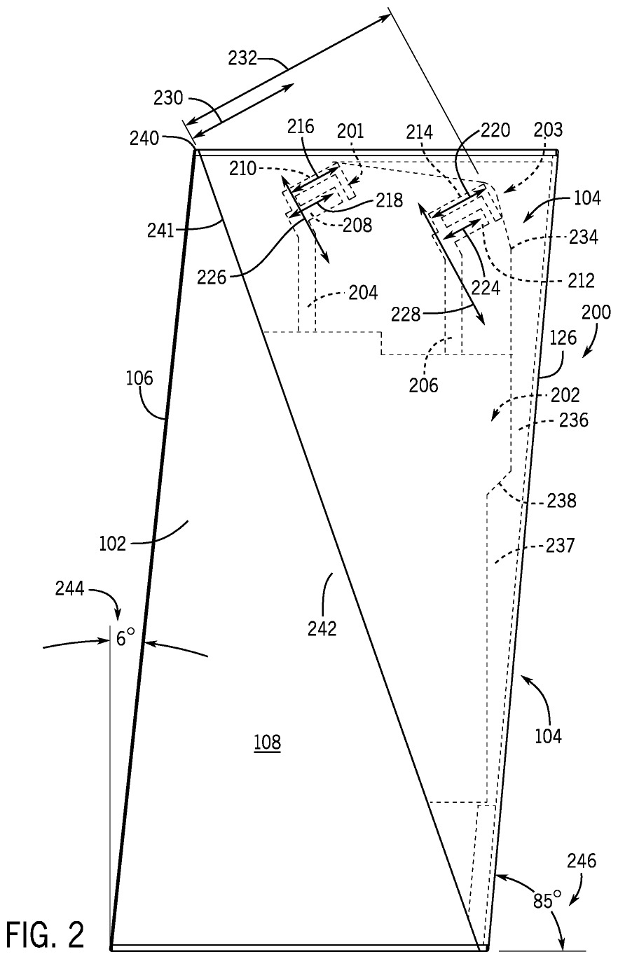

Example ranges of the size of the combined housing can include a width of approximately 5 cm, a height of approximately 20 cm and depth of approximately 8.5 cm. The specific dimensions can vary, however within the general description of the shape of the housing. Furthermore, the antennas as shown herein are configured to be in an upper portion of the non-metal housing portion 104, which is part of the wider portion of the triangle profile of the non-metal housing portion 104. The narrower upper portion of the metal housing portion 102 provides the most impact therefore to the antenna structure. Unless otherwise claimed, the example housing having triangular profiles for side, end and top surfaces can vary. For example, front surface 106 might be rectangular in shape, as well is the bottom surface of the system. Broadly speaking, the system includes a housing having a metal portion and a non-metallic portion and the configuration of the antennas relates to distances and orientations relative to a connecting edge (introduced below in FIGS. 1B and 2) between the metal and non-metal portions and distances from specific points on the antennas to the connecting edge. Therefore, all the other shapes or structure of the housing can vary from the specific examples shown.

In one general description of the housing, a first metal portion can encompass approximately one half of the entire housing and a connecting edge that connects the first metal portion with a second non-metal portion can traverse from a top left corner of the housing to a bottom right corner of the housing (e.g., see FIG. 2). The antenna structure can be configured within the housing proximate to the non-metal portion and be positioned and oriented with respect to the connecting edge. Beyond this general description, the housing or the housing portions can have any shape. The preferred embodiment is shown as having triangular surfaces but the shape can vary.

Feature 113 of FIG. 1A represents connecting cables for connecting the system 100 to a modem or other communication component for enabling mobile devices to gain communication access to a network.

FIG. 1B illustrates an example of the non-metal housing portion 104. A connecting surface or edge 121 generally is configured along the perimeter of an open portion of the housing portion 104. Various structures such as flanges 114, 116, 118, 120, 122 are shown by way of example. These structures are used to connect the non-metal housing portion 104 with the metal housing portion 102. Any type of connecting structure can be used and these are shown by way of example only.

FIG. 1C illustrates a side view of the non-metal housing portion 104. An end surface 126 is shown having a triangular profile. A side surface 110 is shown as well. A second side surface 131 is shown which can also have a triangular profile. Side surface 110 can be positioned on a front portion of the housing 100 and side surface 131 can be connected to the end surface 126 as shown in the various figures. These surfaces can be connected or molded in a single consistent component. When the system disclosed herein is used as a Wi-Fi router, connection portions 128, 130 included on the same side as end surface 126 can be provided to receive an Ethernet connector or other type of connection that can be provided to a modem or other component for communicating data to and from the housing 100. Again, the particular shapes disclosed herein are provided by way of example only. The non-metal portion 104 of the housing does not impact or provides little impact to the radiation pattern of the antennas. The housing structure shown in FIGS. 1B and 1C can vary dramatically from the particular structures shown.

FIG. 1D illustrates a front end view of the metal housing portion 102. Front surface 106 is shown having an example triangular profile. A side surface 132 is shown as well as the side surface 108 each having a triangular profile. In this figure, the metal housing portion 102 is also shown tilted such that a bottom surface 134 is shown. Bottom surface 134 is generally the surface upon which the system rests or which supports the housing 100. As noted above, the shape of the metal portion 102 can vary dramatically from what is shown. The front surface 106, side surface 132, side surface 108 and bottom surface 134 can each be configured as a respective triangle as shown in the figure. The various surfaces can be formed as part of the same contiguous metal housing portion 102.

FIG. 1E illustrates a sectional view through cross section 1E from FIG. 1D. In this view, example structures 138, 140, 142 are provided which can be used in a complementary fashion with one or more of flanges 114, 116, 118, 120, 122 (from FIG. 1B) to connect the metal housing portion 102 with the non-metal housing portion 104. These structures are provided by way of example only.

The structure 136 is also shown by way of example to extend from the interior portion of the metal housing portion 102 into the interior portion of the non-metal housing portion 104 when the two housing portions are connected together. The structure shown can be designed to hold the printed circuit board that contains the antenna structure and associated circuitry disclosed herein. Again, this is an example structure for supporting the printed circuit board described below and can be configured in a number of different ways. The printed circuit board 202 shown herein can be connected to the structure 136 within the housing.

Feature 144 represents a connecting edge of the metal housing portion 102. This generally represents the perimeter of the opening of the metal housing portion 102. This edge can lie within the plane that is generally defined as a plane through which the edge passes and which can be used to determine the relative position and orientation of the antennas that are printed on the printed circuit board as disclosed herein. In FIG. 1E, for example, the plane which contains the connecting edge 144 can be a vertical line given the orientation of the metal housing portion 102 shown in FIG. 1E. The antenna orientation and configuration is generally determined based on the connecting edge 144 and upper portion of the structure of the metal housing portion 102. Other shapes or configurations of the non-metal housing portion 104 and other sections of the metal housing portion 102 are contemplated as within the scope of this disclosure.

The overall example shape of the housing 100 can be described as prismatic or the like. Each surface whether it be a side surface (108, 110) a top surface (112), or front surface (106) is triangular in shape. The housing 100 can sit on the bottom surface 134 that is also triangular in shape as is shown in FIG. 1D.

FIG. 2 introduces other components to the system according to this disclosure. A Wi-Fi router system 200 includes the first metal housing portion 102 and the non-metal housing portion 104. The non-metal housing portion 104 however is partially cut away such that the printed circuit board 202 can be illustrated. The triangular profile of a side surface 108 of the metal housing portion 102 is illustrated. Note that in this example, the system 200 has a tilted configuration. The front surface 106 of the metal housing portion 102 has a tilted or non-vertical orientation having at angle 244 of 6° relative to a vertical line. The tilt of the system 200 can vary and does not have to be exactly 6°. The tilt of the front surface 106 can be zero (vertical) or can be in a range from 1-20°.

A back edge surface or rear surface 126 of the non-metal housing portion 104 is disclosed. The back edge surface 126 is also tilted at an angle 246 by way of example at 85° relative to a horizontal line. Noted that an angle of 85° renders the front surface 106 as not parallel to the back surface 126 in the system 200. The housing can also be configured such that these two surfaces are parallel to each other. The angle 246 can also range from being 90° or less than 85°. FIG. 2 illustrates the housing configuration tilting toward the right. In another aspect, the tilt could also lean in a leftward direction, or not tilt at all.

FIG. 2 shows a small top surface 240 as part of the metal housing portion 102. In this figure, the small portion is not part of the top surface 112 of the non-metal portion 104. The small top surface 240 is shown by way of example only and, in one aspect, the point of the triangular profile of the side surface 108 could be sharper than is shown in feature 240 such that there is less or no top surface component on the top of the metal housing portion 102.

A printed circuit board 202 can be configured within the combined housing portions 102, 104. Feature 242 represents the location or connecting edge at which the metal housing portion 102 connects to the non-metal housing portion 104. The connecting edge 242 can generally represent a hypotenuse of the triangular profile 108 of the metal housing portion 102. A line or a plane can be defined by the configuration of the connecting edge 242. The connecting edge 242 represents the surface along which the connecting edge 121 of the non-metal housing portion 104 connects to the connecting edge 144, 242 of the metal housing portion 102. A plane containing the connecting edge 242 or line can be used to define the orientation or configuration of the antennas 201, 203 on the printed circuit board 202.

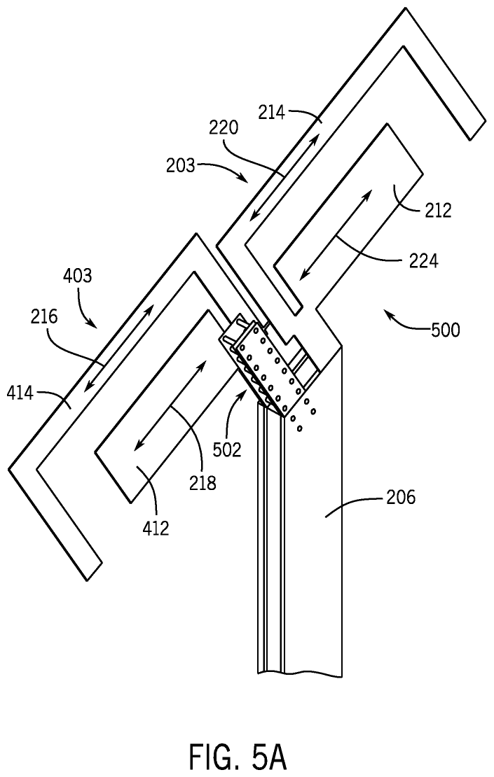

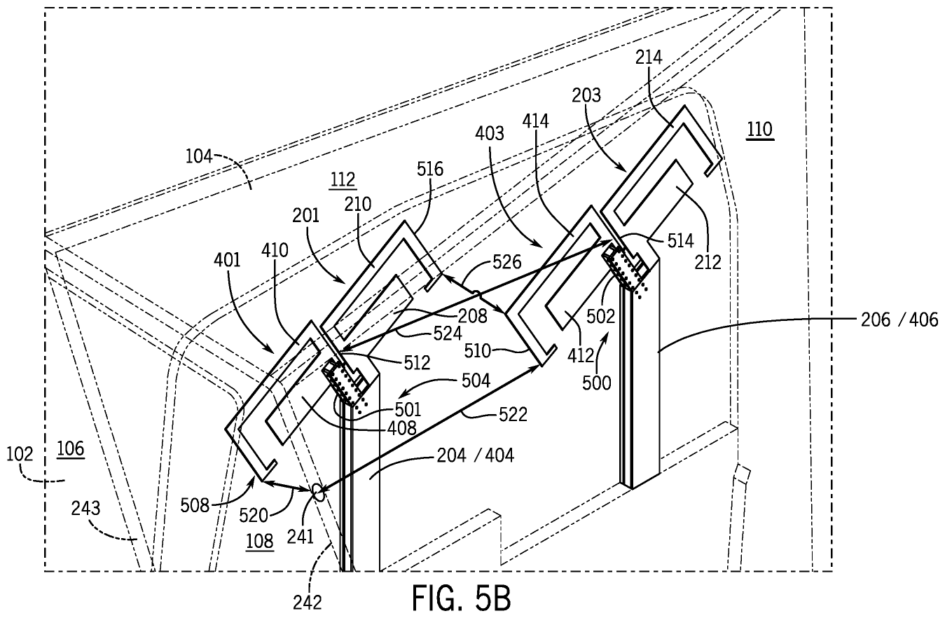

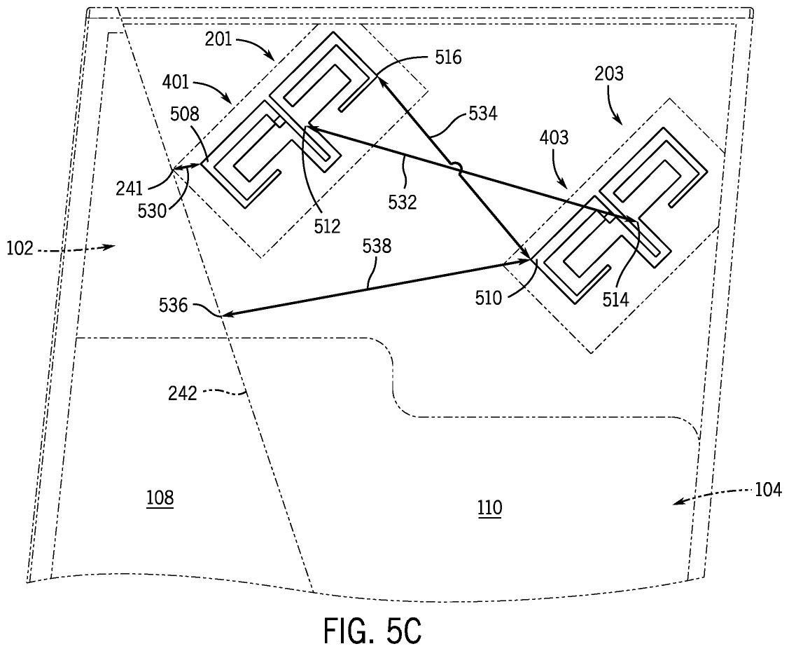

The first antenna 201 is shown with a feed line 204 connecting to a trace 208 and a trace 210. An example current flow for the trace 208 is shown by arrows 218. Another example current flow 216 is shown for the trace 210. Because the metal housing portion 102 is closest to the first antenna 201 along the edge 242, the first antenna 201 is positioned a certain distance away from the edge 242. The distance 230 can be measured from the edge 242 to an end of first antenna 201. The end of the first antenna in this instance can be defined in one example by a portion of the trace 210 that is the furthest away from the edge 242. FIG. 5B illustrates other example distances between the metal housing and the antennas as well as distances between the antennas.

The first antenna 201, and in particular, traces 208, 210, can be configured at approximately a 30° angle relative to a horizontal line. This means that the flow of current represented by arrows 216, 218 can generally be at an angle of 30°. This direction is also approximately normal to the plane defined by edge 242. In other words, the direction of the current denoted by arrows 216, 218 can be between 80° and 100° relative to the plane defined by the edge 242. The configuration of the traces 208, 210 and the resulting flow of current denoted by arrows 216, 218 can result in a radiation direction or radiation pattern as shown by arrow 226. This configuration, in connection with the distance 230 from the edge 242 enables a desirable radiation pattern for the Wi-Fi system 200 such that, for example, Wi-Fi connectivity can be provided to the system 200 for devices within a home.

Point 241 represents an example location along the plane defined by edge 242 that can be used to determine a separation distance or gap between the first and second antennas 201, 203. This point will be discussed in more detail in FIG. 5B which shows a first dipole antenna 504 and a second dipole antenna 500.

A second antenna 203 is shown with its feed line 206, a trace 212, with a corresponding current flow direction denoted by an arrow 224, and a trace 214 with its corresponding current flow direction denoted by an arrow 220. Antenna 203 is configured a distance 232 from the edge 242. The distance 232 can be measured from the connecting edge 242 to a distal end of the antenna 203 (the side of the trace 214 furthest from edge 242). Note that FIG. 5B provides some specific example distances for the various dipole antennas relative to the edge 242 and also between each of the antennas.

The orientation of antenna 203 is similar to the orientation of antenna 201. The radiation direction or pattern for antenna 203 is shown by arrow 228. The radiation direction or pattern associated with arrow 226 is approximately parallel to connecting edge 242 although, as is shown in FIG. 2, the radiation pattern is not exactly parallel. This is the same for radiation direction or pattern associated with arrow 228. FIG. 5A also shows the direction of the respective currents denoted by arrows 216, 218, 220, 224 in the antennas.

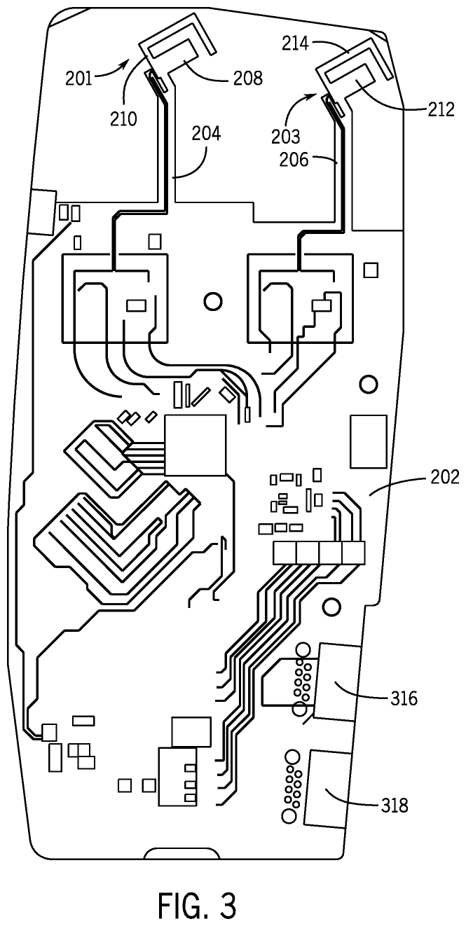

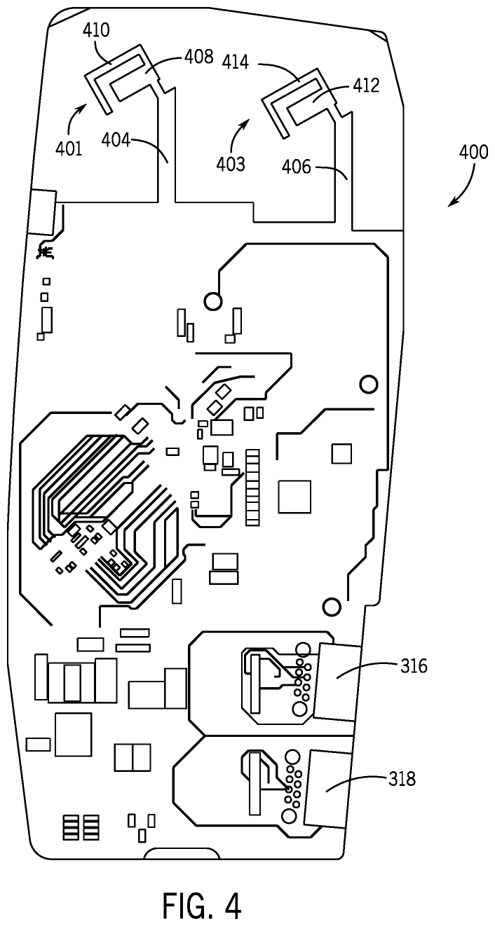

While FIG. 2 shows antennas 201, 203, each of these antennas is only part of a dipole antenna that shall be described more fully below. FIG. 2 provides an example of the overall configuration of the printed circuit board 202 in the housing of the system 200. The shape of the printed circuit board 202 also can be configured to fit within the unique housing configuration. For example, a right side of the circuit board is not simply a straight line. The circuit board in this case is not a simple rectangle. Given the fact that the overall housing configuration shown in FIG. 2 has an angled surface 106 on a front edge and a tilted back surface or rear surface 126, the printed circuit board 202 is configured to fit properly within the overall housing. A right edge of the printed circuit board 202 includes a straight portion 237 that extends to approximately the midway point of the printed circuit board 202 and then which turns at a sharp angle to extend outward from the printed circuit board with a contour 238. The right edge continues as shown in feature 236 until at feature 234 the edge angles back towards the left. The structure will be illustrated in more detail in FIG. 3 and FIG. 4.

The structure of the circuit board 202 is shown only by way of example. However, generally speaking, the circuit board 202 can be configured for efficient printing and to fit within the chosen housing configuration. The circuit board 202 can be configurable such that the antennas 201, 203 can be positioned within an upper area of the overall housing within the non-metal housing portion 104 such that a proper and desirable radiation direction or pattern 226, 228 can be achieved given the existence of the metal connecting edge 242, which is part of the metal housing portion 102.

FIG. 3 illustrates an example printed circuit board 202 that includes various components for processing signals to and from the antennas 201, 203. Trace 208 and trace 210 of antenna 201 are shown in more detail with their example structures. A feed line 204 for the antenna 201 is also shown. Feed line 204 is configured to provide RF signals (generated by components included in the printed circuit board 202) to be radiated by traces 208, 210, and receive RF signals detected by traces 208, 210 to provide to components included in the printed circuit board 202 for processing. The printed circuit board 202 includes a first port 316 and a second port 318 for connecting to a modem or other component that can enable a device to communicate via the Wi-Fi router system 200 with the Internet or other network.

FIG. 4 illustrates another aspect of the printed circuit board 400 that provides additional traces as part of the dipole antennas. Antenna 401 is illustrated with feedline 404, a trace 408 and a trace 410. Antenna 401 and antenna 201 from FIG. 2 combine to yield the first dipole antenna disclosed herein. Antenna 403 is illustrated with feedline 406, a trace 412 and a trace 414. Antenna 203 and antenna 403 in combination represent a second dipole antenna. Note the general shape of the printed circuit boards in FIGS. 3 and 4. The shape is not rectangular and they are angled or tilted to the right. The left side of the printed circuit board has a slight bulge about a third of the way up the length of the printed circuit board 202/400. The right side has an indented portion and then extends approximately one third of the way up the length of the side, after which the side surface angles back towards the central portion of the printed circuit board. The purpose of this printed circuit board configuration is to enable the circuit board to be mounted within the interior of the housing of the Wi-Fi router system 200. The dipole antennas 201/401, 203/403 are located in the upper portion of the housing 200 and at the proper orientation and distance from the metal housing portion 102 and the connecting edge 242.

The direction of current flow in trace 408 is similar to the current flow denoted by arrow 218 in trace 208. The direction of current flow in trace 410 is similar to the current flow denoted by arrow 216 in trace 210. The direction of current flow in trace 412 is similar to the direction of current flow denoted by arrow 224 in trace 212. The direction of current flow in trace 414 is similar to the direction of current flow denoted by arrow 220 in trace 214. FIG. 3 can represent one printed board circuit layer and FIG. 4 can represent another printed board circuit layer that are combined to ultimately provide the two dipole antennas that are used within the system 200.

FIG. 5A illustrates a dipole antenna 500 having a first antenna 203 and a second antenna 403 as introduced above. The feed line 206 is shown along with traces 212, 214 as part of antenna 203 and traces 412, 414 is part of antenna 403. The Wi-Fi protocol IEEE 802.11ac as well as other Wi-Fi protocols can provide communication over multiple bands of frequencies using antennas structured similar to those disclosed herein. For example, traces 214, 414 can be used to communicate at 2.4 GHz and traces 212, 412 can be used to communicate at 5 GHz according to the chosen protocol. As noted above, the 2.4 GHz frequency band includes the range from 2.40-2.48 GHz and the 5 GHz frequency band includes generally 5.10-5.90 GHz. Other frequencies of course can be applicable depending on the antenna structure and radio components within the system. These ranges are only provided by way of example.

While traces 212, 412 are shown as rectangular in shape, and traces 214, 414 are shown as being inverted “U” shaped, it is noted that other trace configurations can be provided as well. These example trace configurations are used to provide a general orientation of the dipole antenna 500 such that the flow of current is at approximately 30° from a horizontal line again such that the radiation pattern associated with arrows 228/226 shown in FIG. 2 is created and at a proper distance from the edge 242 within the particular housing configuration of the system 200. Therefore, other trace structures that achieve the same goal can fall within the scope of this disclosure.

A dual-band balun 502 can be used to minimize the effect of feed line and the ground condition in the antenna structure. The dual-band balun 502 is shown for antenna 403 and is configured between the antenna 403 and the feedline 206/406. A separate balun could also be used for antenna 203 as well. A similar balun 501 (shown below in FIG. 5B) can be used for antenna 401, as well as for antenna 201. The respective balun can be used as an electrical connection between respective antennas and the respective feedlines to make a transition between an unbalanced system (the feedline) and a balanced antenna (the respective dipole antennas). The structure shown in FIG. 5A can be the same for dipole antenna 201/401. FIG. 5A illustrates the direction of the respective currents denoted by arrows 216, 218, 220, 224 in the antennas as well.

FIG. 5B illustrates the configuration of a front antenna 504 that can include antennas 201/401 with a feedline 204/404 and a back antenna 500 which includes antennas 203/403 and a feedline 206/406. This figure also shows the general outline of the housing. Connecting edge 242 connects the metal housing portion 102 and the non-metal housing portion 104. This illustration provides an example of the view of the antennas within the housing and particularly how the antennas can be configured in the non-metal housing portion 104 in relation to the metal housing portion 102. Front surface 106 is shown as well as top surface 112 and side surfaces 108, 110. The top surface 112 can, for example, have a triangular top surface profile.

The respective orientations of the front antenna 504 and the back antenna 500 are shown in FIGS. 5A and 5B as being similar. In one aspect, the respective rotation of the different dipole antennas might be different. For example, front antenna 504 may be rotated 60° relative to the horizontal plane while the back antenna 500 may be rotated 45° relative to the horizontal plane. While this disclosure encompasses any angle of the two dipole antennas, including a vertical orientation, the performance is improved if the two dipole antennas are angled generally at 45° relative to the horizontal plane. As noted above, each antenna can be angled at 45°, or within a range of 30-60° relative to the horizontal plane. In another aspect, one antenna might be angled 35° and another antenna might be angled at 55°. These are all example angles and variations are included within the scope of this disclosure.

FIG. 5B shows in a perspective view of the surfaces 104, 106, 108, 110. Point 241 in FIG. 5B represents an example point on the connecting edge 242 of the metal housing portion 102 and the non-metal housing portion 104. A connecting edge 243 is shown as well on the back of the housing.

An example distance 520 from the point 241 to an end 508 of antenna 504 is 12.97 mm or approximately 13 mm. The preferable range between a point (any point, but an example point 241 is shown) on the connecting edge 242 of the metal housing portion 102 to an end 508 on the front antenna 504 is 5 mm to 20 mm, inclusive. The distance can be measured from the closest portion of the trace having the end 508 thereon to a point 241 on the connecting edge 242. In another example, a particular spacing 522 can be between the point 241 on the metal housing portion 102 and an end 510 of the back antenna 500. This spacing can be approximately 40 mm or within a range of 30 mm to 60 mm, inclusive.

An example spacing can be between the front antenna 504 and the back antenna 500 can be represented by a distance 524 from a front antenna center point 512 to a back antenna center point 514. The spacing can be, for example, 35.85 mm, approximately 35 mm or can be within a range from 25 mm to 45 mm, inclusive. An edge-to-edge spacing 526 between the front dipole antenna 504 at point 516 (on antenna 201) and the back dipole antenna 500 at point 510 (on antenna 403) can be 13.52 mm, or about 13 mm, or within a range of 5 mm to 25 mm, inclusive.

The points 508, 510, 512, 514, 241 are all representative of approximate locations which can be used to determine a distance, spacing, or gap associated with a respective trace or antenna feature. Other points along the traces or connecting edge 242, 243 can also be used in the same general location shown in FIG. 5B.

A length 526 is shown as a distance between a point 516 on antenna 201 to a point 510 on antenna 403. This distance can be approximately 13.52 mm or in a range between 5 mm and 25 mm, inclusive.

The first dipole antenna 401/201 and the second dipole antenna 403/203 can be configured to transmit or receive signals at approximately 2.4 GHz and/or 5 GHz in connection with an IEEE 802.11ac standard or can be configured for other wireless protocols. For example, the first dipole antenna can include 401/201 a first trace 408 and a second trace 208 configured for signals at approximately 5 GHz. The second dipole antenna 403/203 can include a third trace 412 and a fourth trace 212 configured for signals at approximately 5 GHz, or within a range of 5.10-5.90 GHz.

The first dipole antenna 401/201 can include a fifth trace 410 and a sixth trace 210 configured for signals at approximately 2.4 GHz, and the second dipole antenna 403/203 can include a seventh 414 trace and an eighth trace 214 configured for signals at approximately 2.4 GHz, or within a range of 2.40-2.48 GHz. The first trace 408 and the fifth trace 410 associated with the first dipole antenna 401/201 can be associated with a first layer of the printed circuit board. The second trace 208 and the sixth trace 210 associated with the first dipole antenna 401/201 can be associated with a second layer of the printed circuit board. Additionally, the third trace 412 and the seventh trace 414 associated with the second dipole antenna 403/203 can be associated with the first layer of the printed circuit board, and the fourth trace 212 and the eighth trace 214 associated with the second dipole antenna 403/203 can be associated with the second layer of the printed circuit board.

FIG. 5C illustrates a side view of the housing with an example configuration of the antennas 201/401 and 203/403 within the non-metal portion 110. Example spacing is shown between the connecting edge 242 and various points of the antenna 201/401 and antenna 203/403. The difference in spacing between FIG. 5C and FIG. 5B is that FIG. 5B is from a three dimensional perspective and the distances can thus include the distance into the page. The distances shown in FIG. 5C are in a two dimensional side view. For example, point 241 in FIG. 5C on connecting edge 242 can be a distance 530 of approximately 2 mm or within a range of −5 mm to 20 mm, inclusive, from the point 508 on antenna 401. We note that if the range is a negative number, it would mean that a portion of the antenna is configured within the metal housing portion 102. The point 508 can be the closest point on the antenna 501 to the point 241. This example distance 530 represents the apparent distance from the side viewpoint and does not take into account the distance in a third dimension into the page.

Similarly, a distance 538 can represent the side perspective distance between a point 536 on the connecting edge 242 to a point 510 on the antenna 403. This example distance 538 represents the apparent distance from a side viewpoint and does not take into account the distance in a third dimension into the page. This distance can be approximately 34 mm or within a range of 30 mm to 60 mm, inclusive.

A distance 532 is shown between point 512 and point 514 between the antennas 201/401 and 203/403. The distance 532 can be, for example, 35.85 mm, approximately 35 mm or can be within a range from 25 mm to 45 mm, inclusive.

Another distance 534 represents an example side perspective distance between a point 516 on antenna 201 and a point 510 on antenna 403. The distance 534 can be for example 13.38 mm or within a range of 5 to 25 mm, inclusive.

Testing shows that the antenna location, orientation, and separation disclosed herein provide sufficient radiation patterns particularly in the front direction. The metal housing 102 can block the signal and cause shadow regions. Accordingly, configuration of the system disclosed herein can provide generally an omnidirectional radiation pattern that can enable devices within the range of the system with wireless communication access to a network.

In one aspect, the system disclosed herein can be part of a satellite communication system. The Wi-Fi router can communicate data between a terrestrial mobile device and a satellite communication system directly or via a modem or separate component.

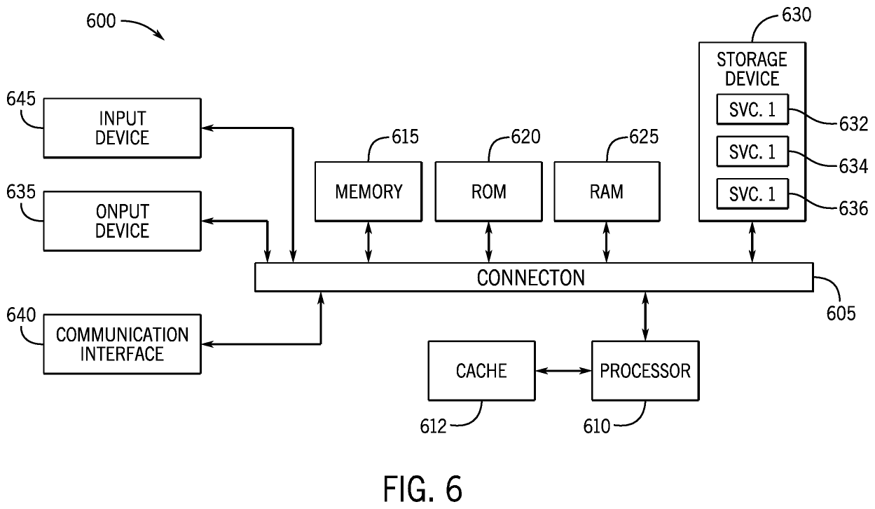

FIG. 6 illustrates an example computer device that can be used in connection with any of the systems disclosed herein. Although the preferred embodiment described above is for a router having one or more antennas, the principles can apply to any computing device having antennas. Thus, any computing device, Internet of Things device, and so forth can include other computing components such as input and output components that may not always be present in a Wi-Fi router. In this example, FIG. 6 illustrates a computing system 600 including components in electrical communication with each other using a connection 605, such as a bus. System 600 includes a processing unit (CPU or processor) 610 and a system connection 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware or software service, such as service 1 632, service 2 634, and service 3 636 stored in storage device 630, configured to control the processor 610 as well as a special-purpose processor where software instructions are incorporated into the actual processor design. The processor 610 may be a completely self-contained computing system, containing multiple cores or processors, a bus, memory controller, cache, etc. A multi-core processor may be symmetric or asymmetric.

To enable user interaction with the device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include services 632, 634, 636 for controlling the processor 610. Other hardware or software modules are contemplated. The storage device 630 can be connected to the system connection 605. In one aspect, a hardware module that performs a particular function can include the software component stored in a computer-readable medium in connection with the necessary hardware components, such as the processor 610, connection 605, output device 635, and so forth, to carry out the function.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B

1-20. (canceled)

21. An antenna system comprising:
a metal housing portion defining a first portion of a housing chamber;
a non-metal housing portion defining a second portion of the housing chamber;
a housing connecting interface defined between the metal housing portion and the non-metal housing portion;
a printed circuit board disposed within the housing chamber coupled to the metal housing portion; and
a first dipole antenna electrically coupled to a first feedline included in the printed circuit board, the first dipole antenna positioned in the second portion of the housing chamber and spaced from the housing connecting interface.

22. The system of claim 21, wherein the first dipole antenna is configured such that a first direction of a first dipole current associated with the first dipole antenna is approximately normal to a plane defined by the housing connecting interface.

23. The system of claim 22, wherein a spacing between a first point on a plane defined by the housing connecting interface and a second point on the first dipole antenna is between about 5 mm and 20 mm.

24. The system of claim 22, further comprising a second dipole antenna electrically coupled to a second feedline included in the printed circuit board, the second dipole antenna positioned in the second portion of the housing chamber.

25. The system of claim 24, wherein the second dipole antenna is configured such that a second direction of a second dipole current associated with the second dipole antenna is approximately normal to the plane defined by the housing connecting interface.

26. The system of claim 24, wherein a spacing between a first point on a plane defined by the housing connecting interface and a second point on the first dipole antenna is between about 5 mm and 20 mm, and wherein a spacing between the first point on the plane defined by the housing connecting interface and a third point on the second dipole antenna is between about 30 mm to 60 mm.

27. The system of claim 26, wherein a first distance between a first central point of the first antenna and a second central point of the second dipole antenna is between about 25 mm and 45 mm.

28. The system of claim 21, wherein the metal housing portion has a first triangular prism shape oriented in a first configuration and the non-metal housing portion has a second triangular prism shape oriented in a second configuration that is inverted relative to the first configuration.

29. The system of claim 28, wherein a first maximum radiation direction of the first dipole antenna is approximately parallel to a plane defined by the housing connecting interface.

30. The system of claim 28, wherein the first dipole antenna is positioned near a base of the second triangular prism shape of the non-metal housing portion.

31. The system of claim 28, wherein the first dipole antenna is oriented approximately 20-50 degrees relative to a plane of a base of the metal housing portion.

32. The system of claim 21, wherein a first maximum radiation direction of the first dipole antenna is approximately parallel to a plane defined by the housing connecting interface.

33. The system of claim 21, wherein the printed circuit board is coupled to the metal housing portion through a structure.

34. The system of claim 21, wherein the non-metal housing portion is RF transparent.

35. The system of claim 21, wherein the printed circuit board extends from the first portion of the housing chamber into the second portion of the housing chamber.

36. A WiFi router apparatus, comprising:
a metal housing portion defining a first portion of a housing chamber;
a non-metal housing portion defining a second portion of a housing chamber, wherein the metal housing portion and the non-metal housing portion are connected along a housing connecting interface to form an enclosure around at least one antenna;
wherein the at least one antenna is located within the second portion of the housing chamber and spaced from the housing connecting interface, and wherein a radiation pattern associated with the at least one antenna is generally parallel to a plane defined by the housing connecting interface; and
wherein heat-generating components of the at least one antenna are physically coupled to the metal housing portion.

37. A WiFi router apparatus, comprising:
a metal housing portion defining a first portion of a housing chamber;
a non-metal housing portion defining a second portion of a housing chamber, wherein the metal housing portion and the non-metal housing portion are connected along a housing connecting interface to form an enclosure around a first antenna;
wherein the first antenna is located within the second portion of the housing chamber, and wherein a spacing between a first point on a plane defined by the housing connecting interface and a second point on the first antenna is between about 5 mm and 20 mm; and
wherein heat-generating components of the first antenna are physically coupled to the metal housing portion.

38. The apparatus of claim 37, further comprising a second antenna, and wherein:
a first distance between a first central point of the first antenna and a second central point of the second antenna is between about 25 mm and 45 mm; and
a second distance between the second antenna and the plane defined by the housing connecting interface is between about 30 mm to 60 mm.

39. The apparatus of claim 37, wherein the first antenna is a dipole antenna, and wherein the dipole antenna is configured such that a first direction of a first dipole current associated with the first dipole antenna is approximately normal to the plane defined by the housing connecting interface.
